(19) United States
(12) Patent Application Publication
(10) Pub. No.: US 2004/0244264 A1
(43) Pub. Date: Dec. 9, 2004

(54) Anti-collapse backend for high volume narrow cod-end pelagic trawl

(76) Inventor: Sherif Adham Safwat, Bainbridge Island, WA (US)

Correspondence Address: Tatiana V. Leshchinsky, #428, 321 High School Rd., Brainbridge Island, WA, 98110, US

(21) Appl. No.: 10/839,674

(22) Filed: May 5, 2004

Related U.S. Application Data
(60) Provisional application No. 60/468,235, filed on May 6, 2003.

(51) Int. Cl. A01K 73/02

(52) U.S. Cl. 43/9.95

(57) ABSTRACT

The technical field of the invention generally concerns pelagic trawls used for catching large tonnages of insignificant air-bladder fish, where narrow, long cod-ends are necessary. The trawl backend of the present invention is designed so as to preclude narrowing of the backend's opening in the region of attachment of the backend to the normally narrow and constrictive codend of the Alaska Pollock Fisheries. The back end design maintains sufficient trawl back end opening so as to optimize fish flow during the entire catch period, with a circumferential stretch measure in that aft portion of the backend bordering the seam with the codend being significantly greater than the average circumferential stretch measure of the codend at the seam to the backend. Light gores are mainly are used in the backend with ribline ropes of pre-determined elongation abilities. Economy of fishing operations is thus improved and ecological conditions are enhanced.

### CLAIM OF PROVISIONAL APPLICATION RIGHTS

This application claims the benefit of United States Provisional Patent Application No. 60/468,235 filed on May 6, 2004

### CROSS REFERENCE(S) TO RELATED APPLICATION(S)

Not Applicable

### GOVERNMENT RIGHTS IN PATENT

Not Applicable

### MICROFICHE APPENDIX

Not Applicable

### BACKGROUND OF THE INVENTION

1. Field of the Invention

The present invention relates generally to trawls and more particularly to Pelagic Trawls for low volume or no volume air-bladder fish specie fisheries, such as the North Pacific Pollock Fishery. Trawls of the present invention are adapted for conserving trawl shape including maintaining desired trawl opening during heavy cod-end loading when narrow cod-ends of large capacity are employed.

2. Description of the Prior Art

High volume fisheries are usually for low value pelagic species, such as Alaska Pollock or blue whiting. In such fisheries primarily due to the relatively high cost of fuel and the relatively low cost of the fish, it is mainly economical to catch large volumes of fish during any particular setting, tow and retrieval of the trawl (i.e. “set”). The catch mass needed to sustain operational economy for such lower value pelagic species for most vessels vary from a desired minimum of at least (80) tones per set, and preferably two hundred (200) tones per set for Alaska Pollock, to at least four hundred (400) tones of fish per set for species such as blue whiting. Thus, Pelagic trawling for such relatively low value pelagic species tend to require high capacity bags (including cod-ends) in order to permit the accumulation and catching of large volumes of fish during a single set.

These large capacity cod ends, designed to hold at least eighty (80) tones or more of fish, and preferably over one hundred tones, generally employ fish pumps to transfer the catch of fish from the trawl's bag to the vessel's hold. The problem arises that in the case of the fish species having very small volume air bladders, including no volume air bladders, the fish become rather too densely packed to permit economic pumping operations, as the densely packed fish bodies are not readily taken up by known pumps. Further exacerbating the transfer of the catch of such fish to the vessel by fish pump, as the pumping operation requires locating the catch close to the hull of the vessel, and idling the vessel, which permits the fish to sink, then due to the lack of sufficient air bladder buoyancy, the entire mass of fish bodies tends to sink after some time in the water, risking pulling the fishing vessel over and capsizing it, especially in high seas.

Alaska Pollock are a fish species whose air bladders do not reliably permit economic or safe pumping operations to transfer the catch from the bag to the vessel, while at the same time being a fish species that most modern fishing vessels must catch in large tonnage in order to operate economically. I.e. catch tonnages generally preferably exceeding two hundred (two hundred) tones per set. Thus, pumping such fish as Alaska Pollock is difficult at best, and has not become popular, despite pumping being the primary method of transferring other high volume pelagic catch species.

For the reason that Alaska Pollock are too difficult and unsafe as well as uneconomical to pump, cod-ends for the Alaska Pollock fishery tend to be narrow and long, so as to permit piecemeal, sectional lifting of approximately forty to sixty (40-60) tone portions of the cod-end at a time out of the water and onto the vessel, emptying of that section of the cod-end into the vessel's hold, then lifting and emptying of the subsequent sections of the cod-end, and so on until the cod-end's fish catch has entirely been transferred to the vessel. The long and narrow shape is utilized as it permits the section-by-section lifting of a manageable tonnage of fish at a time, including in high seas, and as well permits the vessel to maintain sufficient forward speed to keep the cod-end from sinking (due to the lack of significant air bladder buoyancy), neither of which is feasible with wider cod-ends known as “brailer-bags” used for pelagic fish species whose air bladders have sufficient volume so both as to preclude sinking of the fish bodies as well as to preclude dense packing of the fish bodies (thus making pumping of the catch aboard ships preferable to mechanically hauling section-by-section the full bag of fish).

The problem arises that the narrow width of the cod-end requires the aft part of the back end of the trawl to itself adapt to a narrow width corresponding to the maximum diameter of the cod-end at its connection to the trawl. While during fishing operations, as the cod-end progressively loads with greater and greater tonnage of fish bodies, the load on the trawl becomes greater and greater, with increasing tensions on the meshes and supporting lines (e.g. riblines), all of which serve to cause a narrowing of the trawl. Exacerbating this problem is that the Alaska Pollock cod-end in addition to being narrow, is very heavy, even in water, as it is constructed with a great deal of heavy chain riblines so as to permit lifting of the massive sections of the full cod-end into the air without breakage.

Thus, as the connection to the cod-end is narrow at the commencement of the fishing operation, and the massive amounts of chain riblines in the cod-end are virtually impossible to spread apart horizontally at towing speeds using known trawling methods, it is the fish bodies themselves that must forcibly push apart the heavy chain riblines and open horizontally the typical Alaska Pollock cod-end. Therefore, the cod-end is virtually completely closed during towing of even an empty Alaska Pollock cod-end, and upon loading of the cod-end, the narrow connection of the cod-end to the trawl forces rather speedy narrowing, and eventually often a full collapse, of the aft end of the pelagic trawl. Thus, as the Alaska Pollock cod-end loads up, it loses much of its opening, thereby significantly reducing the flow of both water and fish into the cod-end.

The result is that the Pollock fishing vessels tend to be unable to catch the optimal tonnage for an economical fishing operation, or if they can catch the optimal tonnage, must spend progressively more and more time towing in order to catch, say, the final eighty (80) tones of a two hundred (200) tone cod-end, with generally two or three times (2-3×) more energy consumption per unit of fish caught being expended to catch the final third of the fish making up the two hundred (200) tone cod-end as compared to the energy consumed to catch those fish making up the first eighty (80) or so tones. As a result, not only is fuel wasted, but, sadly, a great quantity of fish are damaged but not caught, as the trawl is not functioning optimally. These fish tend to die, either immediately or later from pathology resultant from de-scaling or other injuries caused by the poorly functioning trawl. The bulk of such uncaught fish mortality occurs during the latter portion of the catching of a full narrow cod-end, as the trawl's normally open passage has become nearly fully collapsed due to the tension of the heavy cod-end on the constrictive connection to the narrow, long Alaska Pollock cod-end design.

Various attempts have been proposed to solve these problems described herein above, the most popular of which includes placing a hang percentage into riblines attached to the selvedge of the trawl's back-end. The most commonly used of such approaches to the problem includes a hang percentage that gradually increases in increments of one (1) percent, from zero percent (0%) well ahead of the connection of the trawl to the cod-end, up to six percent (6%) or even seven percent (7%) at or about the connection of the trawl to the cod-end. Other means to create a hang percentage in the selvedges of most of the back end include creating a rather thick or heavy gore (selvedge) along the edge of each panel. As known lacing methods make the selvedge (also “lacing”) approximately three percent (3%) shorter than the stretch measure of the corresponding netting, a fully functional approximately three (3%) hang percentage is achieved by using thick gore bunches (e.g. five to seven [5-7] or more knots per panel edge, making ten to fourteen [10-14] or more knots per corner), as the rather large amount of energy required to elongate such a thick gore bunch to a degree sufficient so as to match in length the stretch measure of the corresponding netting forces primary tension forces along the selvedge and to the cod-end's riblines, in the exact same way as is effected by a back-end's riblines made with a similar hang percentage.

The problem with such approaches is that the resultant direction of loading forces is along the selvedges and/or riblines, which serves to severely disrupt the shape of the trawl, forcing the mesh to receive load from the selvedges and/or riblines, rather than from successively forward mesh rows (which is ideal), thereby cantering meshes away from a designed and preferred orientation, increasing drag, and further reducing both back end opening as well as trawl mouth opening, and concurrent trawl efficiency.

Furthermore complicating the benefits of known solutions to the problem, such long, narrow width cod-ends tend to have rather high hang percentages. For example, hang percentages of ten percent (10%) are not uncommon, with six percent (6%) generally being minimal. The high hang percentages forces the cod-end to pull on the trawl's back end primarily on the corners, i.e. where the panels meet at their peripheral edges, and where are situated riblines in the back-end and/or selvedges, thus also forcing directional forces along the backend's selvedges and/or riblines, with the resultant technical problems described above.

Thus, it is apparent that attempted solutions to the problems in the art as described supra, while having improved the state of the art from what existed before implementation of such attempted solutions, have not fully solved the problems in the field, and have only permitted the current state of the art, with its concurrent limitations, as described above.

### BRIEF SUMMARY OF THE INVENTION

The present invention provides for a trawl having a design that prevents collapse of the trawl in any portion of the trawl, while maintaining a maximum opening of the trawl at its connection to the cod-end, including the narrow cod-ends used in the Alaska Pollock fishery, thus permitting more economical, and more ecologically friendly fishing operations.

An object of the present invention is to provide a non-collapsible pelagic trawl for use with the narrow cod-ends of the Alaska Pollock fishery, that maintains a constant or near constant rate of catch while employed with large volume, narrow width cod-ends.

Another object of the present invention is to provide a non-collapsible pelagic trawl for use with the narrow cod-ends of the Alaska Pollock fishery that forces directional tension loads primarily from mesh to mesh mainly in a direction generally in line with the long dimension of a netting sheet and the length of the trawl, while simultaneously transferring such directional loading forces, in the location of the last aft sections of the trawl from the meshes of the last sections of the trawl to the riblines of the trawl, and thus to the riblines of the cod-end, thereby permitting optimal cod-end function.

Yet another object of the present invention is to provide such a non-collapsible pelagic trawl for use with the narrow cod-ends of the Alaska Pollock fishery that is simple, durable, cost effective, easy to maintain and economical to manufacture.

Briefly, the present invention includes a pelagic trawl where the circumferential stretch measure of the mesh making up that side of the seam (including “join”) connecting the trawl's back-end to the cod-end (“cod-end” herein including “brailer-bag”, “packer-tube”, “intermediate-tube” or the like) is substantially greater than the stretch measure of the average circumference of the cod-end proximal the seam, while simultaneously having a significantly lower hang percentage than the cod-end's hang percentage

An advantage of the present invention is greater economy of fishing operations and improved environmental and ecological impact upon the fisheries.

These and other features, objects and advantages will be understood or apparent to those of ordinary skill in the art from the following detailed description of the preferred embodiment.

### BRIEF DESCRIPTION OF THE DRAWINGS

FIG. 1 is an expanded detail top view of the back end of the trawl of the present invention;

FIG. 1a is an expanded detail side view of the starboard side of the back end of the trawl of the present invention;

FIG. 1b is an expanded detail side view of the port side of the back end of the trawl of the present invention;

FIG. 2 is a general top view of the trawl of the present invention and including that portion of back end shown in FIG. 1;

FIG. 2a is a general side view of the starboard side of the trawl of the present invention and including that portion of the back end shown in FIG. 1a;

FIG. 2b is a general side view of the port side of the trawl of the present invention and including that portion of the back end shown in FIG. 1b.

### DETAILED DESCRIPTION

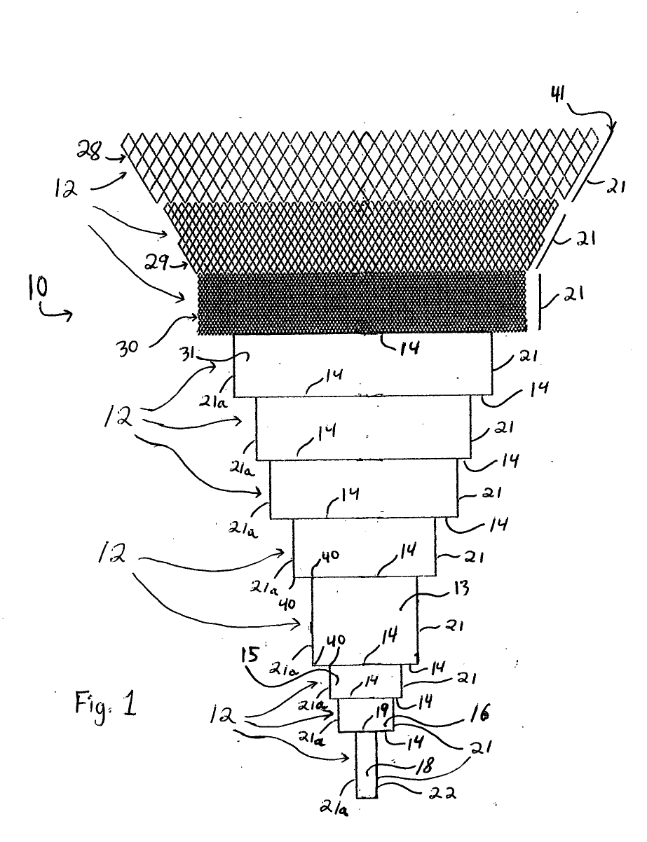

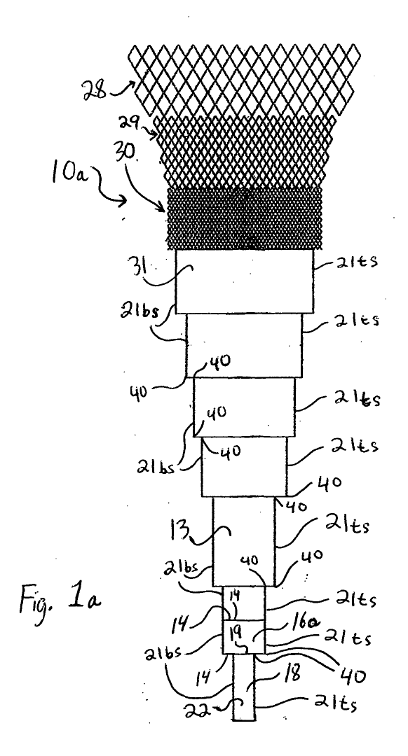

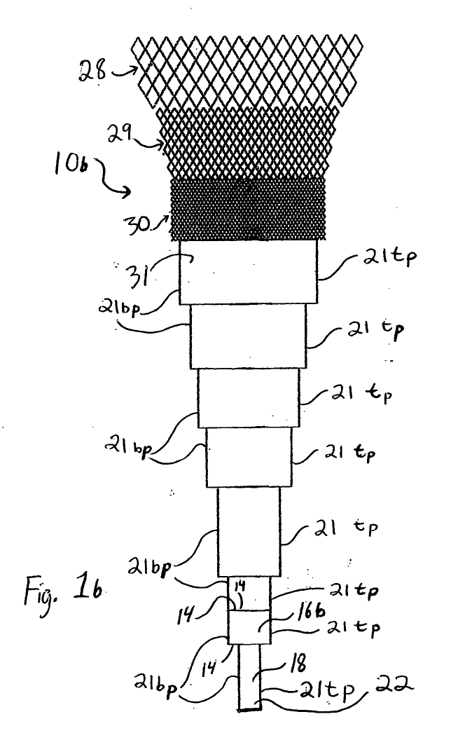

In reference to FIG. 1, shown is an expanded top view shared both by the top panel as well as by the bottom panel of the back end of the present invention. That is, FIG. 1 shows a view of the exterior of the top panel of the backend, as well as a view of the interior of the bottom panel of the back end, both taken from directly atop the back end of the present invention. More specifically, the backend and trawl of the present invention in the preferred embodiment includes a four (4) seam (i.e. “four panel”) trawl, and both the top panel as well as the bottom panel share the same general back end panel construction as indicated by reference numeral 10 in FIG. 1, while both the starboard side panel and the port side panel as well share a same general construction (see FIGS. 1a and 1b), though a different construction than that shared by the top and bottom panels.

The starboard side panel of the backend of the trawl of the present invention is shown in FIG. 1a, as indicated by reference numeral 10a. The port side panel of the trawl of the present invention is shown in FIG. 1b, and indicated by reference numeral 10b.

In reference to FIGS. 1, 1a and 1b:

The back end includes various mesh panel sections 12 arranged sequentially and seamed together at seams 14. Mesh panel sections 12 are formed of meshes that tend to decrease in size starting with larger sizes in more forward sections of the back end, and including mesh of progressively smaller sizes in progressively more aft sections of the back end. For example, mesh sizes in mesh panel sections 28, 29, 30 and 31 are four (4) meter, two (2) meter, one (1) meter, and four hundred millimeter (400 mm), respectively.

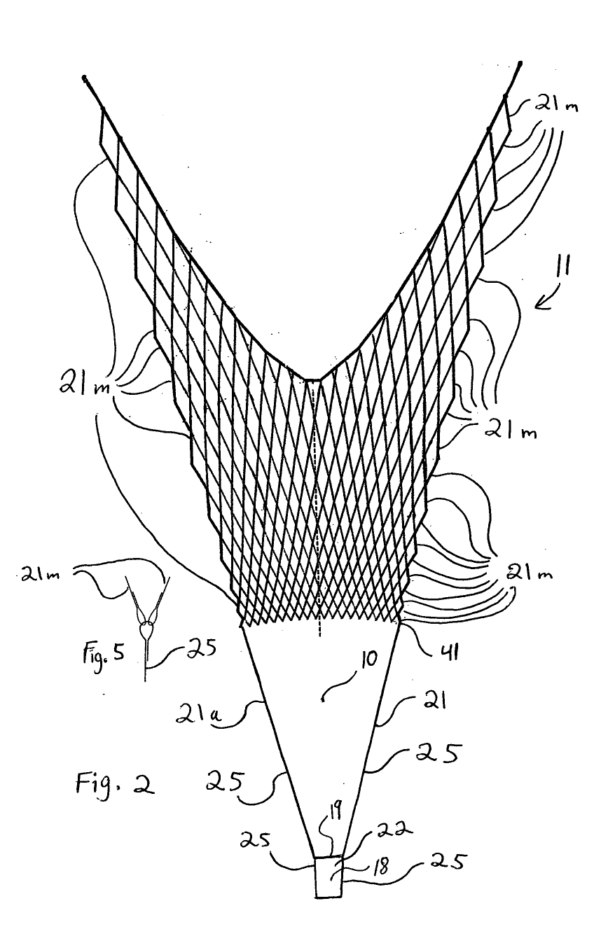

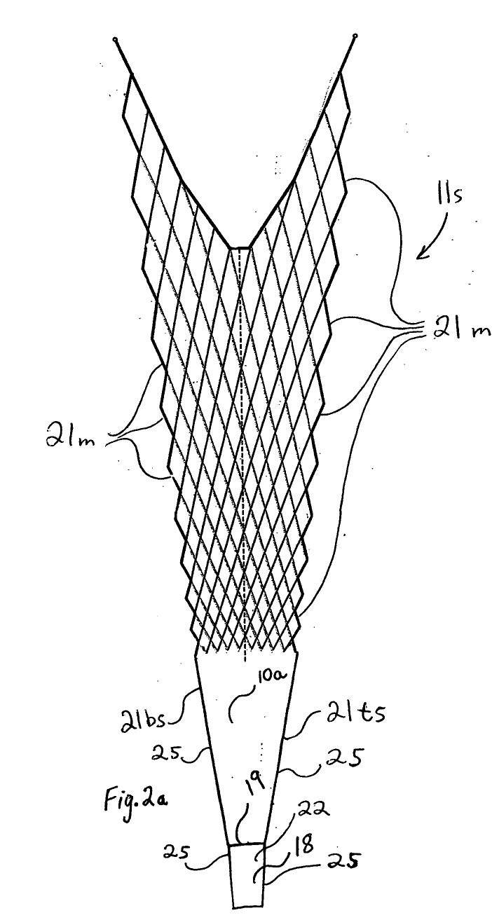

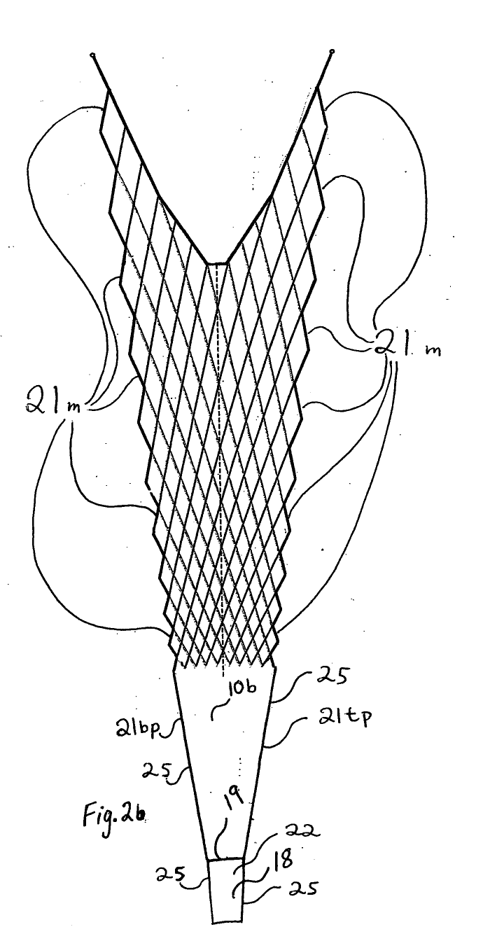

In further detail, mesh panel sections 12 are preferably mainly of a “no-taper” or “all-point cut” design. That is, the mesh panels 12 have a quadratic shape when laid down on a floor and spread out so that all the same sized meshes of a particular mesh panel are open a uniform amount. In the “no-taper” or “all-point cut” embodiment used for the majority of the mesh panels of the present invention, as indicated by mesh panels including and more aft in the trawl than mesh panel section 30 having a four hundred millimeter (400 mm) mesh size, the reduction of the trawl's overall circumference from fore to aft is accomplished mainly by a reduction in the meshes sizes from front to aft. The various and same sized meshes adapt to various degrees of opening as forced upon them by tensile forces acting upon the trawl during field operations, resulting in a smoothly tapering trawl, as indicated by the smoothly tapering, generally conical outline of the various views of the trawl of the present invention shown in FIGS. 2, 2a and 2b.

In particular reference to FIG. 1, selvedges 21 are disposed along the starboard side of the back end, and thus along the starboard edge of the various mesh panel sections 12 making up both the top as well as the bottom side of the back end. Selvedges 21a are disposed along the port side of the back end, and thus along the port edge of the various mesh panel sections 12 making up the top as well as the bottom side of the back end.

In reference to FIG. 1a, selvedges 21ts are disposed along the top starboard side of the back end, and thus along the top edge of the various mesh panel sections 12 making up the starboard side of the back end. Selvedges 21bs are disposed along the bottom starboard side of the back end, and thus along the bottom edge of the various mesh panel sections 12 making up the starboard side of the back end.

In reference to FIG. 1b, selvedges 21tp are disposed along the top port side of the back end, and thus along the top edge of the various mesh panel sections 12 making up the port side of the back end. Selvedges 21bp are disposed along the bottom port side of the back end, and thus along the bottom edge of the various mesh panel sections 12 making up the port side of the back end.

Selvedge 21 of the top side and selvedge 21ts of the starboard side are attached together to make up a gore bunch located along the upper starboard corner of the trawl. Likewise, Selvedge 21 of the bottom side and selvedge 21bs of the starboard side are attached together to make up a gore bunch located along the lower starboard corner of the trawl.

Similarly, selvedge 21a of the top side and selvedge 21tp of the port side are attached together to make up a gore bunch located along the upper port corner of the trawl. Likewise, Selvedge 21a of the bottom side and selvedge 21bp of the port side are attached together to make up a gore bunch located along the lower port corner of the trawl.

In all, there are four (4) gores in the preferred embodiment of the four sided trawl of the present invention, one (1) separating each side of the trawl and including the selvedges from the mesh panel sections of two (2) sides. The selvedges from various mesh panel sections 12 are permanently attached to one another at points 40 disposed along seams 14 defining the boundary and connection between various mesh panels 12. Each of the four (4) gore bunches of the trawl's back end preferably also include a ribline, as indicated by reference numeral 25 (see FIGS. 2, 2a and 2b).

Each gore bunch and its corresponding ribline are permanently attached to one another, which attachment either may be made before or simultaneous to the manufacture of any particular gore bunch. Each gore bunch and its corresponding ribline attaches to front end selvedge mesh bars 21m at point 41, via a connection method including interlocking clamped or spliced eyes, with two (2) selvedge mesh bars attaching to one (1) ribline (see FIG. 5).

For example, selvedge half mesh bars from the starboard edge of the top side of the front end (11) of the trawl (see FIG. 2), and selvedge half mesh bars belonging to the top edge of the starboard side of the front end 11s of the trawl(see FIG. 2a), connect to one another at the points, without any gore or ribline, and further would attach at point 41 to that certain ribline disposed along the top starboard edge of the backend of the trawl. That ribline corresponding to the top starboard edge of the trawl would itself be attached to selvedges 21 and 21ts (see FIGS. 1 and 1a).

The sections of gore bunches attached to riblines 25 corresponding to those mesh panel sections 12 that are disposed further than two hundred (200) mesh lengths deep forward of where seam 19 joins codend 22 to the remainder of the back end, are preferably light gore bunches, i.e. having less than twelve (12) knots per gore bunch, and preferably less than seven (7) knots per gore bunch. This is so as to prevent excessive resistance to elongation from the gore bunches, and permit planned, engineered resistance to elongation by selection of an appropriate rope for the riblines. Excessive resistance to elongation being problematic and undesirable for the reasons described supra. The preferred hang percentage of riblines in this part of the back end, and in more forward sections of the trawl, including in selvedge mesh 21m relative to other mesh of the front end(see FIGS. 2, 2a and 2b), is zero percent (0%). Thus, highly elastic, pre-shrunk ropes easily stretched at least ten percent (10%) with minimal effort are desired for riblines in such portions of the trawl.

However, in sections of back end gore bunches attached to riblines 25 corresponding to those mesh panel sections 12 located within two hundred (200) mesh lengths deep of where seam 19 joins codend 22 to the remainder of the back end may be heavy gore bunches. This is especially so as riblines 25 corresponding to such gore bunch sections preferably include a rope made of a material that has less than 10 percent (10%) elastic elongation, such as a well balanced braided UHMWPE rope, and preferably less than seven percent (7%) elastic elongation. A rope for these sections of riblines that is highly resistant to permanent elongation, while having an elastic elongation within the parameters described supra, is preferable, so as to prevent permanent deformation and/or breakage of this portion of the trawl during lifting of the codend out of the water and into the air, especially during high seas. An example of a superior version of such a rope are ropes including a coverbraid and a core, the core itself selected from a rope made by Hampidjan, HF of Iceland, sold under the trade name of “DUX” and “Dynex”. DUX includes a heat-stretched UHMWPE rope.

The preferred hang percentage of riblines in this part of the back end is between zero percent (0%) and seven percent (7%), with one percent (1%) being preferred for those ribline sections corresponding to mesh panel sections located within one hundred (100) mesh lengths deep forward of seam 19, and at least six percent (6%) being preferred for those ribline sections corresponding to mesh panel sections located aft of(away from the mouth of the trawl) seam 19, i.e. in codend 22.

Codend 22 is from one hundred (100) meshes deep with mesh sizes between one hundred four millimeter (104 mm) and one hundred fourteen millimeter (114 mm), or larger mesh sizes, if it attaches to yet another codend, or is at least five hundred (500) meshes deep, if it does not attach to yet another codend. Various terms and constructions associated with such terms may be used for the codend 22, including “Packer-Tube”, “Intermediate-Tube”, “Packer”, “Bag”, and the like. Furthermore, several codends of similar or varying constructions may be attached to one another, in order to make up codend 22.

For example, codend 22 may be formed with its first 100 meshes deep having riblines that are lightweight in water, made of coverbraided “DUX”, and with it subsequent 400 meshes deep having riblines that are either (i) made of DUX with light ballast chain on the bottom riblines and light floats on the top riblines, for better water flow; or (ii) made of heavy chain, with large floats on the top riblines to counteract the weight of the chain. Various combinations and construction arrangements for forming codend 22 should be apparent to those ordinarily skilled in the art having read the disclosure of the present invention.

In order to achieve the objects of the present invention, the circumferential stretch measure of at least the mesh panel sections making up of that aft portion of the trawl's backend bordering forward (toward the trawl's mouth) side of seam 19 connecting the trawl's back-end to cod-end 22 is substantially greater in value than the stretch measure of the mesh making up the average circumference of the cod-end for that portion of the codend proximal seam 19. Simultaneously, the riblines corresponding to those aft mesh panel sections bordering the forward side of seam 19 have riblines formed with a significantly lower hang percentage than the hang percentage mainly included in the cod-end's riblines.

More specifically, the cod-end has a hang percentage of between four to ten percent (4- 10%), and preferably from six to ten percent (6-10%), with six to seven (6-7%) percent common.

Concurrently, the trawl's backend mesh panel sections that border seam 19 connecting the trawl's backend to the cod-end 22 have riblines and/or gores formed with a hang percentage that is preferably from zero (including less than zero) to three percent (3%), while preferably being between zero and two percent (0-2%), with from one to two percent (1-2%) being most preferred, depending primarily upon materials chosen. For the purposes of this disclosure, length measurements for determining hang percentages described herein are taken with the selvedge, ribline rope, other line or stretched mesh under approximately (fifty) 50 pounds of tension.

For example, mesh panel sections 18 making up the four (4) sides of codend 22 may have (fifty) 50 open meshes across (i.e. perpendicular to the length of the trawl), of 114 mm mesh size. Concurrently, mesh panel sections 16 in the top and bottom sides of the trawl (see FIG. 1) would have from one hundred (100) to one hundred fifty (150) open mesh across of the same size. That is, the mesh panel sections bordering seam 19 in the top and bottom sides of the trawl have a two to three times (2-3×) or more greater mesh count than the mesh panel sections of the corresponding top and bottom side of the codend.

Side mesh panel sections 16a and 16b (see FIGS. 1a and 1b) making up the starboard and port sides of the trawl, respectively, preferably would have at least one hundred (100) meshes across of the same mesh size, giving at least two times (2×) more mesh across than the side mesh panel sections of the codend.

As a general rule, in the preferred embodiment of the present invention the average circumferential stretch measure of that portion of the backend located within ten (10) meters of the boundary between the codend and the backend has at least twice (2×) the circumferential stretch measure distance compared to the average circumferential stretch measure of the codend, and preferably approximately two and a half times (2.5×) the stretch measure of the average stretch measure of the codend, with a forty percent (40%) greater circumferential stretch measure being minimal. It is preferred that the starboard and port sides of the back end, and also of the entire trawl, as shown in FIGS. 1a, 1b, 2a and 2b, mainly have at least one third (⅓), and preferably approximately one half (½) less width (corresponding mesh across) than corresponding portions of the top and bottom sides of the trawl (see FIGS. 1 and 2), while the front end meshes employ self spreading meshes, such as trawl mesh made by Hampidjan HF, of Iceland, and sold under the trade name “Helix”. Simultaneously, it is preferred that all sides of the codend have similar widths.

In another embodiment, those sections of the backend located at least within one hundred (100) mesh lengths deep of juncture 19 of codend 22 to the trawl's backend may also have similar widths, or at least are within one third (⅓) of each other's widths, with the mesh panel sections 12 in the side panels 10a and 10b potentially being less wide than the mesh panel sections 12 in the top and bottom panels. The preferred mesh for the majority of the backend, and especially for mesh sizes less than five hundred millimeter (500 mm), is that type of mesh taught in published PCT application having international publication number WO 02/095107(A1). While the above example has used differing mesh across counts of similar mesh size to achieve the given ratios of mesh on each side of seam 19, oppositely, but with the same result, differing mesh sizes of similar mesh count may also be used to achieve the desired ratio for the overall stretch measure difference between those mesh panel sections making up that portion of the back end of the trawl bordering the forward side of seam 19, and those codend mesh panel sections 18 bordering the aft side of seam 19. When different mesh counts are used, in say a two to one (2:1) mesh count ratio, then two (2) mesh on the forward side of seam 19 are connected to one (1) mesh on the aft side of seam 19, and so on. However, if differing mesh sizes of the same mesh count are used on either side of seam 19 in order to achieve the desired ratio of circumferential stretch measure, say with one (1) two hundred millimeter (200 mm) mesh on the forward side of seam 19 for each one (1) one hundred (100 mm) mesh on the aft side of seam 19, then the mesh are attached one to one (1:1). Various combinations of mesh size and overall mesh across count are useful, provided that the mesh size contains the fish, and that the desired circumferential stretch measure and ratio of stretch measure between the aft end of the trawl bordering the forward side of seam 19 and corresponding portions of the codend bordering the aft side of seam 19, is achieved.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

What is claimed is:

1. A trawl including a backend and a codend, the backend attached to the codend at a seam, the seam including (i) a backend mesh panel section bordering the forward side of the seam, and (ii) a codend mesh panel section bordering the aft side of the seam, the backend mesh panel section and the codend mesh panel section each having:
a) a width; and
b) a hang ratio,
comprising:
a stretch measure of meshes across the width of the backend mesh panel section having a greater value then the stretch measure of meshes across the width of the codend mesh panel section; and, a hang ratio corresponding to the backend mesh panel section that is lesser than a hang ratio corresponding to the codend mesh panel section, whereby backend opening in the region of the seam is maintained at a desired value and fish flow, resultant economy of fishing operations and ecological impact upon the fishery is enhanced.

2. The trawl of claim 1 wherein the hang ratio of the back end mesh panel section is formed by a structure selected from a group consisting of (i) a ribline; and (ii) a gore.

3. The trawl of claim 1 wherein the backend includes a gore bunch having less than seven (7) knots.

4. The trawl of claim 1 wherein the backend includes a gore bunch having less than eleven (11) knots.

5. The trawl of claim 1 wherein riblines included in the codend are formed by a heat-stretched UHMWPE rope, whereby greater codend flow is achieved.

6. The trawl of claim 1 wherein riblines included in mesh panel sections removed greater than two hundred (200) mesh lengths deep forward of the seam are more elastic than riblines included in mesh panel section located within two hundred (200) mesh lengths deep of the seam.

7. The trawl of claim 1 wherein backend mesh panel sections having mesh sizes of less than five hundred millimeters (500 mm) include all-point cut mesh panel sections.

8. The trawl of claim 1 wherein the stretch measure of meshes across the width of the backend mesh panel section have a value at least forty percent (40%) greater then the stretch measure of meshes across the width of the codend mesh panel section.

9. The trawl of claim 1 wherein the stretch measure of meshes across the width of the backend mesh panel section have a value at least one hundred percent (100%) greater then the stretch measure of meshes across the width of the codend mesh panel section.

10. The trawl of claim 1 wherein the stretch measure of meshes across the width of the backend mesh panel section have a value at least two and a half times (2.5×) the stretch measure of meshes across the width of the codend mesh panel section.

11. A trawl including a backend and a codend where the circumferential stretch measure of a portion of the backend bordering the seam of the backend with the codend comprises a greater value than the average circumferential stretch measure of the codend, whereby backend opening is maintained, fish flow, resultant economy of fishing operations and ecological impact upon the fishery is enhanced.

12. The trawl of claim 11 wherein the circumferential stretch measure of the portion of the backend bordering the seam of the backend with the codend is at least forty percent (40%) greater than the average circumferential stretch measure of the codend.

13. The trawl of claim 11 wherein the circumferential stretch measure of the portion of the backend bordering the seam of the backend with the codend is at least one hundred percent (100%) greater than the average circumferential stretch measure of the codend.

14. The trawl of claim 11 wherein the circumferential stretch measure of the portion of the backend bordering the seam of the backend with the codend is at least two and a half times (2.5×) the average circumferential stretch measure of the codend.

15. A trawl including a backend and a codend, the backend including a portion located within ten (10) meters of where the backend meets the codend, the codend having an average circumferential stretch measure and an average hang ratio, the portion of the backend located within ten (10) meters of where the backend meets the codend comprising:
an average circumferential stretch measure that is greater than the average circumferential stretch measure of the codend, and a hang ratio that is at least two percent (2%) less than the average hang ratio of the codend,
whereby backend opening is maintained, fish flow, resultant economy of fishing operations and ecological impact upon the fishery is enhanced.

16. The trawl of claim 15 wherein the portion of the backend located within ten (10) meters of where the backend meets the codend includes an average circumferential stretch measure that is at least forty percent (40%) greater than the average circumferential stretch measure of the codend.

17. The trawl of claim 15 wherein the portion of the backend located within ten (10) meters of where the backend meets the codend includes an average circumferential stretch measure that is at least one hundred percent (100%) greater than the average circumferential stretch measure of the codend.

18. The trawl of claim 15 wherein the portion of the backend located within ten (10) meters of where the backend meets the codend includes an average circumferential stretch measure that is at least two and a half times (2.5×) the average circumferential stretch measure of the codend.

19. The trawl of claim 15 wherein backend mesh panel sections having mesh sizes of less than five hundred millimeters (500 mm) include all-point cut mesh panel sections.

20. A trawl including a backend and a codend, the codend comprising riblines formed by heat stretched UHMWPE, whereby water flow through the codend and fishing vessel economy is enhanced.
